(19) United States
(12) Patent Application Publication
(10) Pub. No.: US 2018/0007943 A1
(43) Pub. Date: Jan. 11, 2018

(54) Garlic Chile Oil

(71) Applicant: Ranjeet Singh, Reseda, CA (US)

(72) Inventor: Ranjeet Singh, Reseda, CA (US)

(21) Appl. No.: 15/206,559

(22) Filed: Jul. 11, 2016

(51) Int. Cl. A23L 3/00

(52) U.S. Cl. CPC A23L 27/105; A23L 3/00; A23V 2002/00

(57) ABSTRACT

The specific preparation and cooking of specific ingredients to create a sauce. The sauce may serve or be intended for dipping and/or as a condiment, to serve on top of food items for added flavor.

### BACKGROUND

The embodiments of the present disclosure generally relate to condiment ingredient preparation and cooking and, more particularly, to the use of ingredients to produce a unique condiment to be served and consumed by consumers.

### SUMMARY OF THE DISCLOSURE

Certain embodiments provide a method generally including the peeling and mincing of garlic cloves.

Certain embodiments provide a method generally including the blending chile peppers in a blender or food processor.

Certain embodiments provide a method generally including the cooking of minced garlic in 100% olive oil.

Certain embodiments provide a method generally including the mixing and stir-frying of garlic, oil, and chili peppers.

Certain embodiments provide a method generally including letting the mixture sit for flavor infusion.

### BRIEF DESCRIPTION OF DRAWINGS

So that the above recited features of the present disclosure can be understood in detail, a more particular description of the disclosure, summarized above, may be had by reference to the embodiments, some of which are shown in the appended pictures. It is to be noted, however, that the appended pictures illustrate only typical embodiments of this disclosure and are therefore not to be considered limiting of its scope, for the disclosure may admit to other equally effective embodiments.

FIG. 1 Illustrates the mincing of garlic as part of the preparation process.

FIG. 2 Illustrates the minced garlic and blended chile peppers in the preparation process prior to cooking.

FIG. 3 Illustrates the stir fry process of the garlic, 100% olive oil, and chile pepper mixture.

FIG. 4 Illustrates the completion of the cooking process for the garlic, 100% olive oil, and chile mixture.

FIG. 5 Illustrates the mixture of the garlic, 100% olive oil, and chile pepper mixture, placed in a container for cooling. The perspective is from above the container.

FIG. 6 Illustrates the mixture of the garlic, 100% olive oil, and chile pepper mixture, placed in a container. The perspective is from in front of a bottled container.

FIG. 7 Illustrates the ratios of the ingredients of the mixture of the garlic, 100% olive oil, and chile peppers to achieve desired tase.

### DETAILED DESCRIPTION

Embodiments of the present disclosure will allow for the preparation, and cooking of the mixture of garlic, chile de arbol, chile Catarina, and 100% olive oil to create a condiment to be utilized as a dipping sauce or to serve on the top of food items.

As a result, the techniques provided herein may add desired flavor to food items.

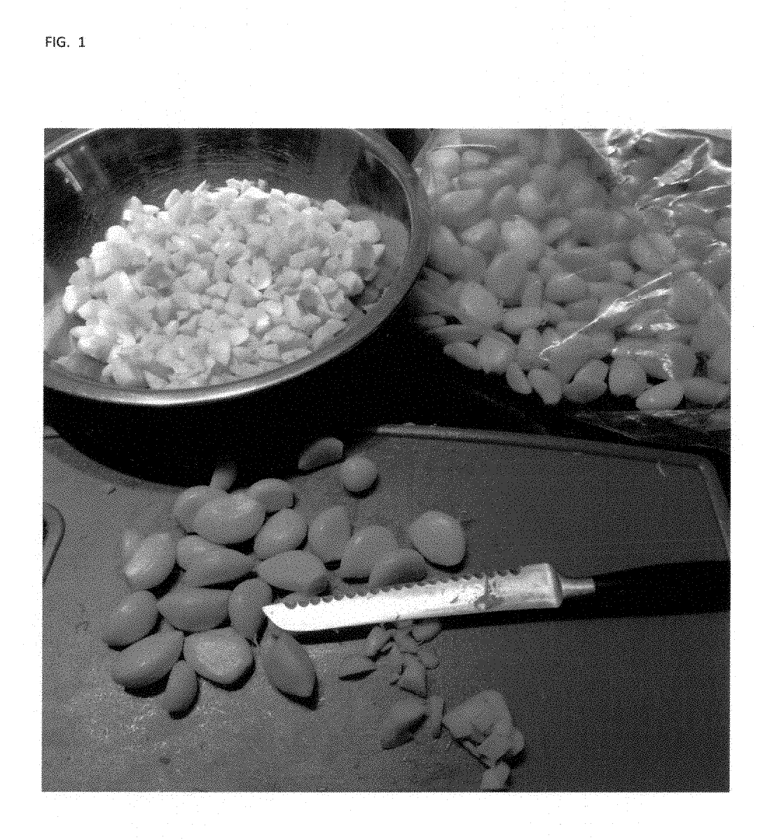

FIG. 1. depicts the act of chopping and mincing garlic cloves to reach the desired size for consumption.

Once the desired amount of garlic has been minced, it is to be placed in a clean container for later use.

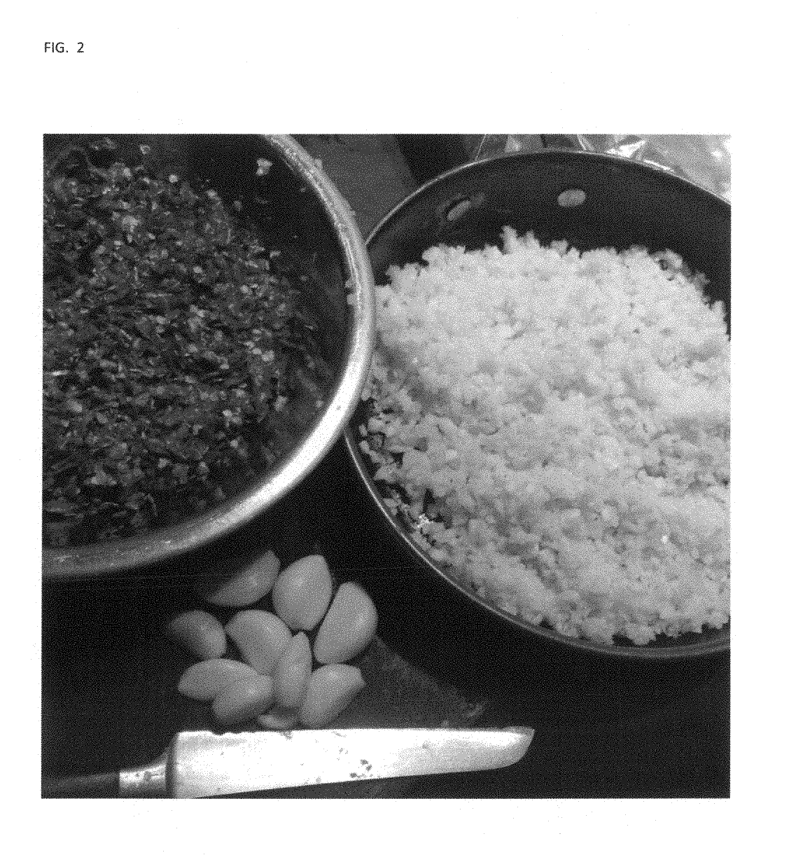

FIG. 2. depicts the processed chile's in a bowl next to the fully minced garlic.

The desired amount of chiles need to be placed into a blender or food process and blended until flaky.

Once blended, the mixture of chiles should be placed into a clean container for later use.

The minced garlic is to be browned to a soft-to-touch consistency, with a slightly translucent look, in minimal 100% olive oil in a sauce pan that is the appropriate size for the portion being prepared.

Once the garlic is browned; the balance of the 100% olive oil, and chile mixture are to be added in to the sauce pan.

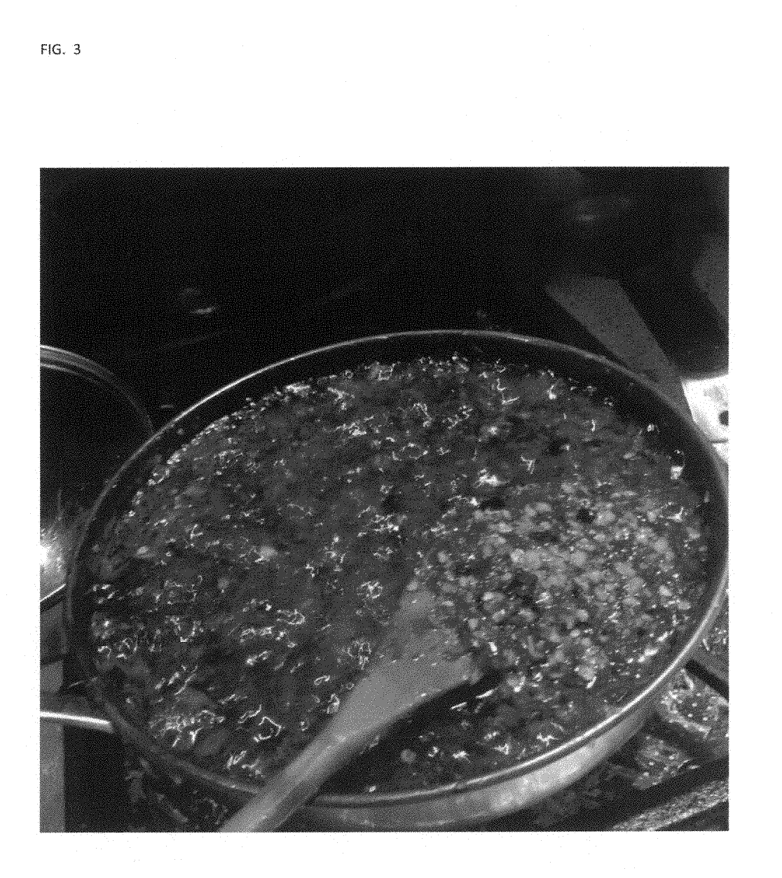

FIG. 3. depicts the mixture of the garlic, 100% olive oil, and chile pepper all in the pan cooking. The mixture will cook for 10-15 minutes, over medium heat, needing longer cook time for bigger batches.

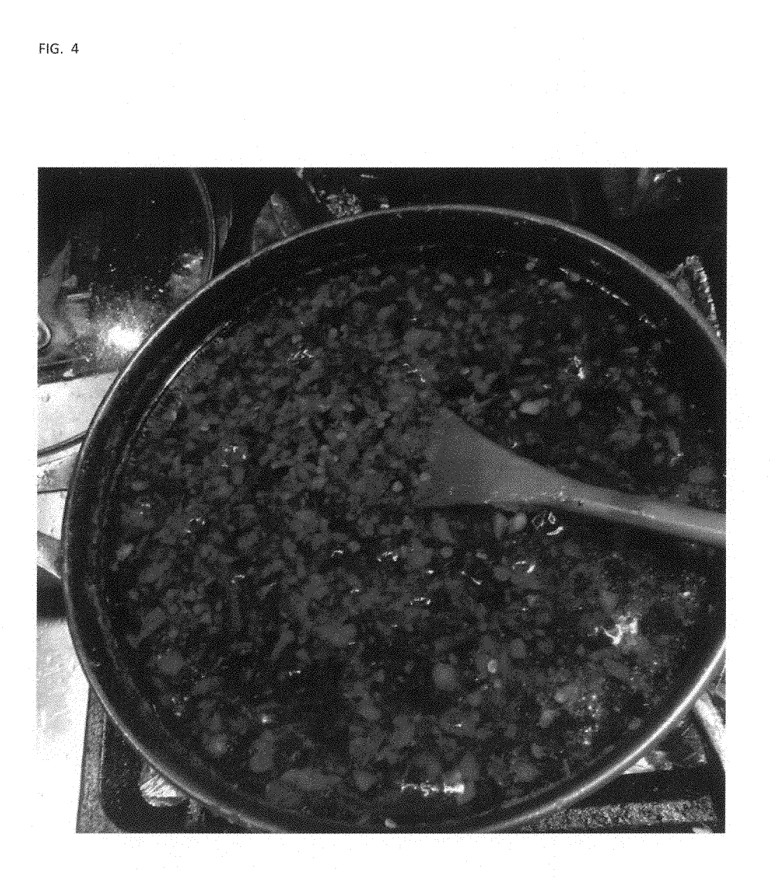

FIG. 4. depicts the sauce at the end of the cooking process. There will be a slight reduction in oil, due to the cooking process.

Once the mixture has cooled, the mixture is transferred into containers and allowed to sit for 3-5 days for flavor infusion.

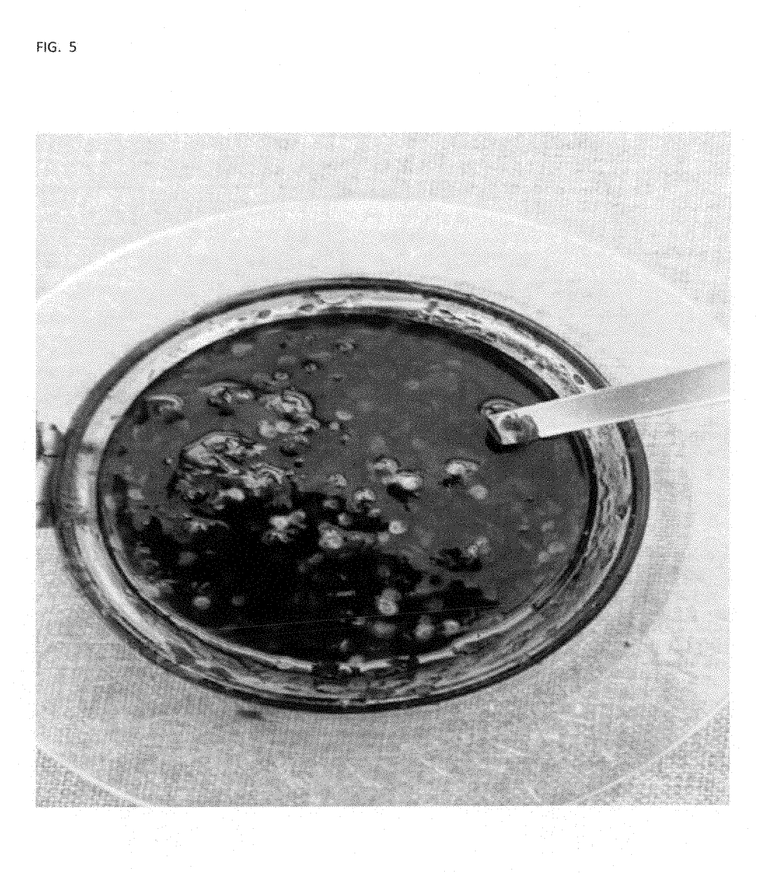

FIG. 5. depicts the mixture in an open container from the top perspective.

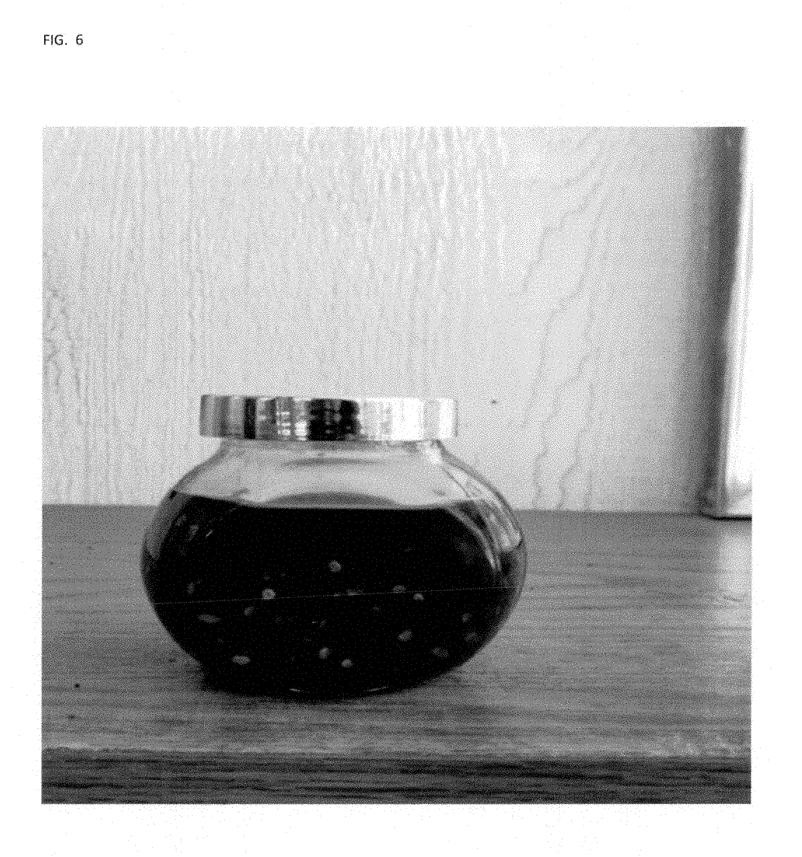

FIG. 6. depicts a front view of the mixture in a sealed container

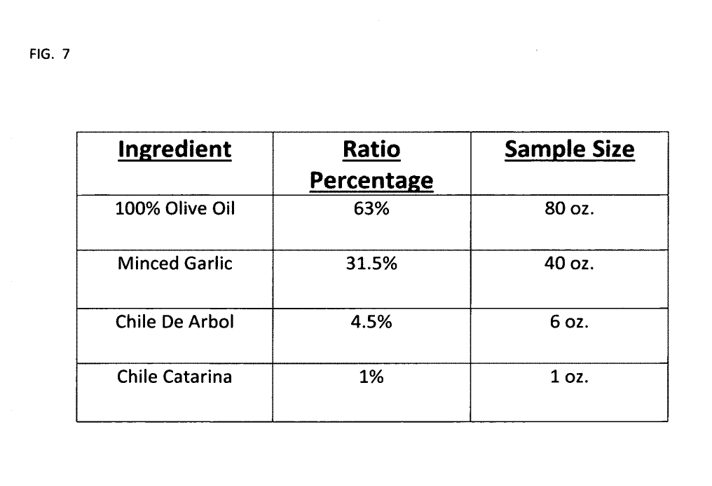

FIG. 7. depicts the ratio of ingredients utilized to achieve desired taste of the mixture.

It is to be understood that the claims are not limited to the precise measurements and process steps illustrated above. Various modifications, changes and variations may be made in the arrangement, operation and details of the methods listed above without departing from the scope of the claims.

What is claimed is:

1. A condiment comprising of Garlic, Chile de Arbol, Chile Catarina, and 100% olive oil to be utilized for consumption as a dipping sauce, or topping of food items.

2. The condiment from claim 1 where the garlic is minced and sautéed in a nonstick pan.

3. The condiment from claim 1 where an equal amount of chile de arbol, and chile Catarina processed in a food processor, and added to sautéed garlic, and mixed.

4. The condiment from claim 1 where 100% olive oil is added to the mixture of garlic and chile de arbol, and chile catarina.

5. The condiment from claim 1 where the mixture of garlic, chile de arbol, chile Catarina, and 100% olive oil, is placed in a glass jar, and stored in a cool, dry environment for 5 days to develop flavor.
